(19) United States
(12) Patent Application Publication
(10) Pub. No.: US 2025/0224520 A1
(43) Pub. Date: Jul. 10, 2025

(54) ADAPTIVE CRYSTAL TUNING FOR IMPROVED POSITIONING

(71) Applicant: QUALCOMM Incorporated, San Diego, CA (US)

(72) Inventor: Supreet HUILGOL, Santa Clara, CA (US)

(21) Appl. No.: 18/409,060

(22) Filed: Jan. 10, 2024

(51) Int. Cl. G01S 19/23; H04W 24/02

(52) U.S. Cl. CPC G01S 19/235; H04W 24/02

(57) ABSTRACT

Techniques for adaptive tuning of a crystal oscillator (XO), having a crystal (XTAL), in a wireless device are provided. An example of a method for adaptive tuning of the XO includes measuring performance parameters of the wireless device based on field conditions of the wireless device with an at least one sensor; calibrating XO parameters of the wireless device with the performance parameters to generate updated XO parameters; and tuning the XO with the updated XO parameters.

### BACKGROUND

Global navigation satellite system (GNSS) related devices are commonplace for many location determination applications. For these GNSS related devices to function accurately, the devices should meet the key performance indicator (KPI) specifications for GNSS signal reception. In order to meet the KPI specifications, a GNSS related device utilizes a crystal-controlled clock oscillator (XO) that includes a crystal (XTAL) oscillator. A XTAL oscillator is an electronic oscillator circuit that uses a piezoelectric XTAL as a frequency-selective element. The oscillator frequency is often used to keep track of time to provide a stable clock signal for digital integrated circuits, and to stabilize frequencies for radio transmitters and receivers. To improve the performance of a XTAL oscillator, especially over temperature, frequency adjustment electronic circuitry may be added to the XTAL oscillator to form an XO. In general, an XO has XO parameters that control different aspects of the XTAL such as, for example, XTAL temperature, decay factor, thermal transients, hysteresis, infinite impulse response (IIR), thermistor selection, etc.

Generally, in order to meet the KPI specifications for a GNSS related device, the XO parameter should be tuned utilizing an XO parameter optimization (XPO) software tool during the preproduction stage of the GNSS related device. In this example, the GNSS related device generally includes a printed circuit board (PCB) that populates many, if not all, of the electronic components, including the XO, of the GNSS related device.

Unfortunately, when mass producing a specific GNSS related device, variations in the production stage may cause problems in meeting the KPI specifications for all of the produced GNSS related devices because of variations in the electronic components (i.e., the hardware) and the processes utilized to produce the GNSS related devices. Some of these variations include variations in the XTALs utilized to produce the GNSS related devices because, generally, each XTAL produced by a given vendor has a slight variation in performance that should be compensated for with the XO parameters. Moreover, XTALs produced by different vendors will also have an additional variation in performance between the vendors. These hardware differences, production processes utilized, and potential field conditions that the GNSS related devices may be exposed to contribute to the performance variation of the GNSS related devices.

Known approaches to address these issues include XPO tuning selected GNSS related devices with distinctive characteristics for the worst-case scenarios (e.g., extreme temperature, high frequency offset, etc.). The distinctive characteristics may include, for example, different PCB and/or XTAL combinations. Once the XPO tuning has been completed, the most optimal XO parameter among all the GNSS related devices is selected as a result of an XO simulation playback (XSP) that is performed during the pre-production stage of the GNSS related devices. The XSP simulation is performed utilizing software tools that play back all the tuned XO parameters of the distinctive GNSS related devices on one another to obtain the most optimal XO parameters that can meet the majority of the KPI specifications for all the GNSS related devices. These optimal XO parameters are later written into non-volatile memory to all the GNSS related devices during the production stage of the GNSS related devices.

However, this approach is not optimal for the different GNSS related devices that are deployed in the field because while most of the GNSS related devices may function within the KPI specifications at the pre-production stage, a significant number will not when deployed because of the hardware differences, production processes utilized, and the field conditions that the GNSS related devices are exposed to while deployed. Specifically, the XPO tuning was performed for the worst-case scenario (e.g., extreme temperature, high frequency offset, etc.,) on selected devices with distinctive characteristics such as different PCB and/or XTALs. As such, some of the possible GNSS test conditions and corner cases are not considered for the XPO tuning of these GNSS related devices. As a result of utilizing the XSP, the optimal XO parameters are then NV written to all the GNSS related devices during the production stage of each GNSS related device even though some of the possible GNSS test conditions and corner cases are not considered. Moreover, in this approach, the XPO tuning and XSP is executed externally to the GNSS related devices utilizing XO software tools and then NV written to the GNSS related device. Therefore, the limitation to perform XPO and XSP for all possible GNSS test conditions and corner cases can lead to a risk of the GNSS related devise failing the GNSS KPI specifications in the field.

### SUMMARY

Techniques for adaptive tuning of a crystal oscillator (XO), having a crystal (XTAL), in a wireless device are provided. An example of a method for adaptive tuning of the XO includes measuring performance parameters of the wireless device based on field conditions of the wireless device with an at least one sensor; calibrating XO parameters of the wireless device with the performance parameters to generate updated XO parameters; and tuning the XO with the updated XO parameters.

Further, a wireless device is provided for adaptive tuning of the XO. An example of the wireless device includes a crystal oscillator (XO) having a crystal (XTAL); at least one transceiver; at least one sensor; at least one memory; and at least one processor, in signal communication with the XO, the at least one transceiver, the at least one sensor, and the at least one memory, the at least one processor configured to: measure performance parameters of the wireless device based on field conditions of the wireless device with the at least one sensor; calibrate XO parameters of the wireless device with the performance parameters to generate updated XO parameters; and tune the XO with the updated XO parameters.

Further, another wireless device is provided for adaptive tuning of the XO. An example of the wireless device includes means for measuring performance parameters of the wireless device based on field conditions of the wireless device; means for calibrating XO parameters of the wireless device with the performance parameters to generate updated XO parameters; and means for tuning the XO with the updated XO parameters.

Further, a server for generating an optimal set of XO parameters for a wireless device having a XTAL is provided. The server includes at least one transceiver; at least one memory; and at least one processor, in signal communication with the at least one transceiver, and the at least one memory, the at least one processor configured to: receive, via the at least one transceiver, a plurality of sets of XO parameters from a plurality of wireless devices, wherein each set of XO parameters have been tuned to an XO of a corresponding wireless device; determine the optimal set of XO parameters from the plurality of sets of XO parameters, and transmit, via the at least one transceiver, the optimal set of XO parameters as an assistance signal to the plurality of wireless devices, wherein the optimal set of XO parameters are configured to tune the corresponding XO of each wireless device.

Further, techniques for generating an optimal set of XO parameters for the wireless device are provided. An example of a method for generating the optimal set of XO parameters includes receiving, at a server, a plurality of sets of XO parameters from a plurality of wireless devices, wherein each set of XO parameters have been tuned to an XO of a corresponding wireless device; determining the optimal set of XO parameters from the plurality of sets of XO parameters, and transmitting, from the server, the optimal set of XO parameters as an assistance signal to the plurality of wireless devices, wherein the optimal set of XO parameters are configured to tune the corresponding XO of each wireless device.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE DRAWINGS

FIG. 1 is a simplified diagram of an example wireless communications system.

FIG. 2 is a system block diagram of components of an example user equipment shown in FIG. 1.

FIG. 3 is a system block diagram of components of an example transmission/reception point shown in FIG. 1.

FIG. 4 is a system block diagram of components of an example server shown in FIG. 1.

FIG. 5 is a functional system block diagram of an example of an implementation of a wireless device for adaptive crystal (XTAL) tuning of a crystal oscillator (XO) within the wireless device in accordance with the present disclosure.

FIG. 6 is a system block diagram of the network entity, shown in FIG. 5, in signal communication with a plurality of wireless devices in different geographic locations in accordance with the present disclosure.

FIG. 7 is a flowchart of an example of an implementation of a method, performed by the wireless device, shown in FIG. 5, for adaptive XTAL tuning of the XO of the wireless device.

FIG. 8 is a flowchart of an example of an implementation of a method, performed by a network entity, shown in FIG. 5, for adaptive XTAL tuning of the XO of the wireless device.

FIG. 9 is a flowchart of another example of an implementation of a method, performed by the wireless device, shown in FIG. 5, for adaptive XTAL tuning of the XO of the wireless device.

FIG. 10 is a flowchart of another example of an implementation of a method, performed by the network entity, shown in FIG. 5, for adaptive XTAL tuning of the XO of the wireless device.

### DETAILED DESCRIPTION

Techniques are discussed herein for adaptive tuning of a crystal oscillator (XO), having a crystal (XTAL), in a wireless device are provided. In this example, the XO may be adaptively tunned by measuring performance parameters of the wireless device based on field conditions of the wireless device with an at least one sensor; calibrating the XO parameters of the wireless device with the performance parameters to generate updated XO parameters; and tuning the XO with the updated XO parameters. Moreover, if assistance data is available from a remote network entity (e.g., a server), an optimal set of XO parameters for the wireless device may be generated by the network entity and transmitted to the wireless device to use as the updated XO parameters for tuning the XO of the wireless device. In this example, the optimal set of XO parameters may be generated by receiving, at the network entity, a plurality of sets of XO parameters from a plurality of wireless devices, wherein each set of XO parameters have been tuned to an XO of a corresponding wireless device; determining the optimal set of XO parameters from the plurality of sets of XO parameters, and transmitting, from the network entity, the optimal set of XO parameters as an assistance signal to the plurality of wireless devices, where the optimal set of XO parameters are configured to tune the corresponding XO of each wireless device. The network entity may then transmit the optimal set of XO parameters to the wireless device and the wireless device may utilize the optimal set of XO parameters as the updated XO parameters for tuning the XO of the wireless device. In this disclosure, the wireless device may be a device that includes a global navigation satellite system (GNSS) receiver or other radio frequency (RF) protocols such as, for example, the Institute of Electrical and Electronic Engineers (IEEE) 802.11 (i.e., Wi-Fi®), IEEE 802.15.1 (i.e., Bluetooth®), IEEE 802.15.4 (i.e., ZigBee), Near Field Communication (NFC that is an RFID standard which includes ISO/IEC 14443 and FeliCA), wireless wide area network (WWAN), etc. In this disclosure, the term “optimal” set of XO parameters refers to the XO parameters that have been determined through iteration and/or testing to be the best in accordance with one or more performance parameters based on the iterations/tests performed as discussed herein and based on desired performance (e.g., as determined by a set of one or more performance parameter values). There may be a theoretically better combination of XO parameters that are not iterated/tested that would yield a better set of the one or more performance parameter values.

In general, utilizing these techniques, a wireless device (having an XO) may include device logs for the XTAL and the printed circuit board (PCB) utilized during fabrication of the wireless device. These device logs may include default XO parameters (also referred to as golden XO parameters) that are utilized to initially operate the wireless device. The techniques described then dynamically adjust the initial default XO parameters by initially comparing the default XO parameters against the key performance indicator (KPI) values for the wireless device to detect any instantaneous failures and then dynamically adjust the XO parameters against KPI values so as to meet the KPI values. This comparison may be an iterative process utilizing narrow band in-phase and quadrature components (NBIQ) iterations across potential XO parameters, where the wireless device determines the optimal XO parameters to utilize in adjusting the XO. The KPI values may be selected from the XO temperature, XO temperature slope, XO temperature acceleration, NBIQ of a received GNSS signal (herein interchangeably referred to as a Global Positioning System (GPS) signal), a maximum acceleration of a satellite (SV) of a constellation of GNSS satellites, and the cycle slip count of a carrier phase cycle of the received GNSS signal.

In a first embodiment, the techniques described could be run on the wireless device itself, so the wireless device optimizes the XO parameters on-the-fly under field conditions. In a second embodiment, a network entity (e.g., a server) can publish geo-specific models of the XO parameters for wireless devices to use when the wireless devices are covered by the geo-specific models. In another embodiment, the network entity can provide multiple models across multiple devices to test out XO parameters before publishing a finalized model of the XO parameters. In yet another embodiment, the network entity could take contextual information into account for proactively updating model of XO parameters.

In general, by utilizing these techniques, the wireless device is able to control the XO with a process that is dynamic, adaptive, automatic, more accurate, reliable, and is optimal or approximately optimal. These techniques also eliminate the process of utilizing XO parameter optimization (XPO) software tools and XO simulation playback (XSP) during the preproduction stage of the wireless device. Moreover, these techniques allow the XO parameters to be tuned in less time the previous solutions.

Items and/or techniques described herein may provide one or more of the following capabilities, as well as other capabilities not mentioned. Other capabilities may be provided and not every implementation according to the disclosure must provide any, let alone all, of the capabilities discussed.

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi® networks (e.g., based on IEEE (Institute of Electrical and Electronics Engineers) 802.11, etc.) and so on. Two or more UEs may communicate directly in addition to or instead of passing information to each other through a network.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

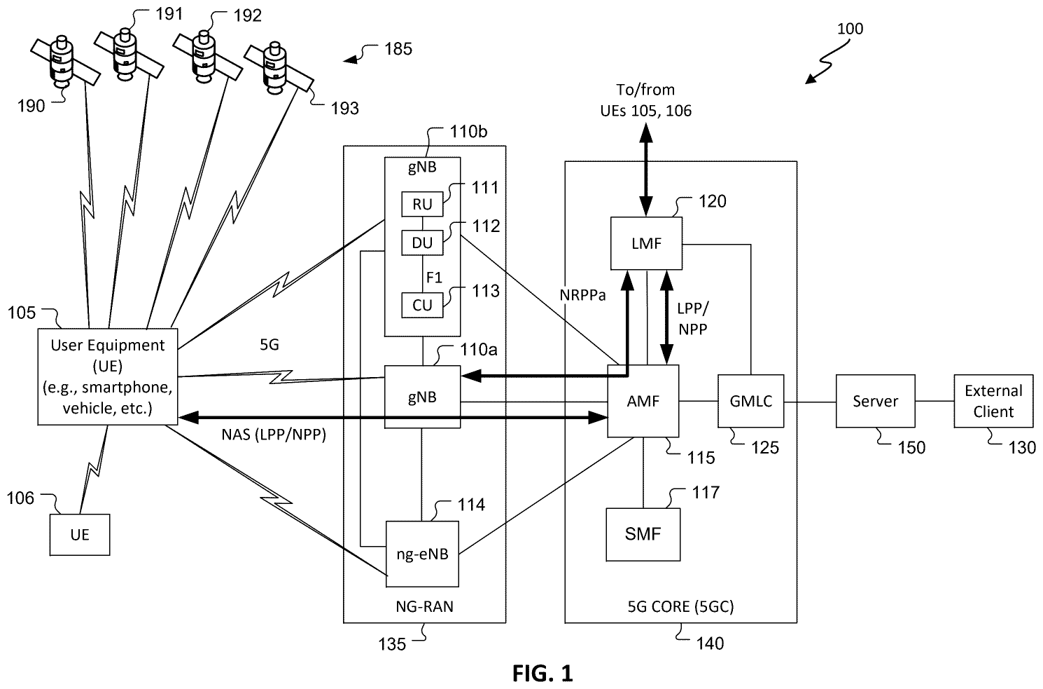

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or another device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi®, WiFi®-Direct (WiFi®-D), Bluetooth®, Bluetooth®-low energy (BLE), Zigbee®, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g., a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi® communication, multiple frequencies of Wi-Fi® communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi® (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH). Direct wireless-device-to-wireless-device communications without going through a network may be referred to generally as sidelink communications without limiting the communications to a particular protocol.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi® (also referred to as Wi-Fi®), Bluetooth® (BT), Worldwide Interoperability for Microwave Access (WiMax®), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi® Direct (WiFi®-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g., the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g., by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi® AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such implementations, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi® access for the UE 105 and may comprise one or more WiFi® APs. Here, the N3IWF may connect to the WLAN and to other elements in the 5GC 140 such as the AMF 115. In some implementations, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other examples, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi® APs, an MME, and an E-SMLC.

As noted, in some examples, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the position of the UE.

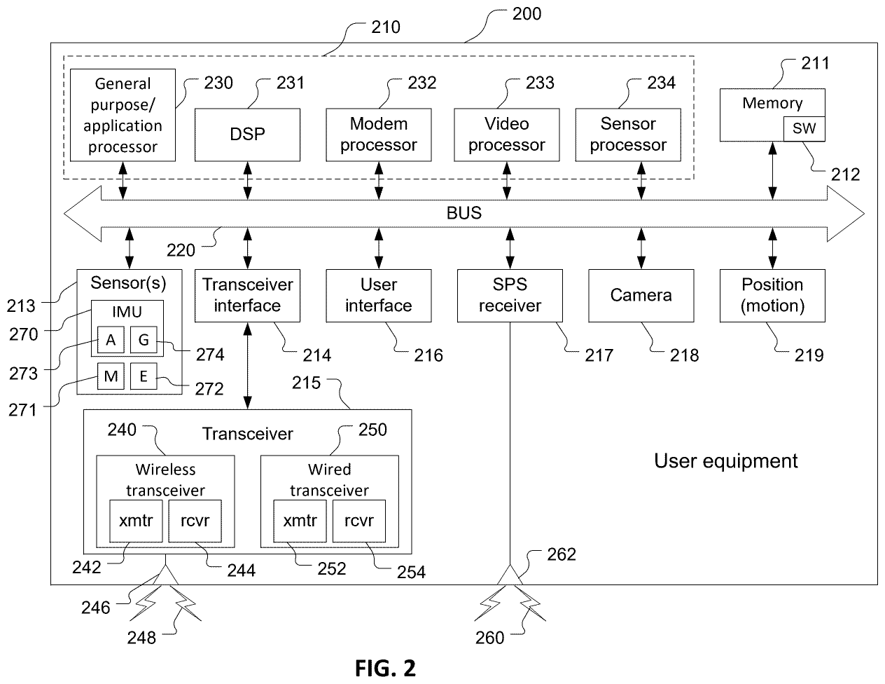

Referring also to FIG. 2, a UE 200 may be an example of one of the UEs 105, 106 and may comprise a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 may be a non-transitory storage medium that may include random access memory (RAM), flash memory, disc memory, and/or read-only memory (ROM), etc. The memory 211 may store the software 212 which may be processor-readable, processor-executable software code containing instructions that may be configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise, for example, one or more accelerometers 273 (e.g., collectively responding to acceleration of the UE 200 in three dimensions) and/or one or more gyroscopes 274 (e.g., three-dimensional gyroscope(s)). The sensor(s) 213 may include the one or more magnetometers 271 (e.g., three-dimensional magnetometer(s)) to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations. The sensor(s) 213 may comprise one or more of other various types of sensors such as one or more optical sensors, one or more weight sensors, and/or one or more radio frequency (RF) sensors, etc.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and may report the relative displacement/distance (e.g., via dead reckoning, or sensor-based location determination, or sensor-assisted location determination enabled by the sensor(s) 213). In another example, for relative positioning information, the sensors/IMU may be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and the gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a GPS receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

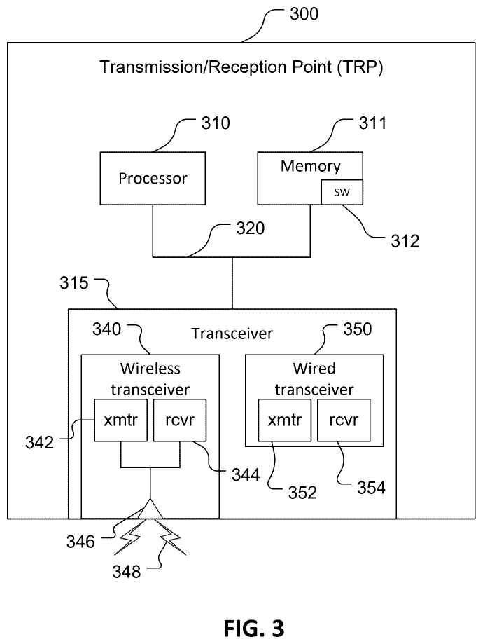

Referring also to FIG. 3, an example of a TRP 300 of the gNBs 110a, 110b and/or the ng-eNB 114 may comprise a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by the LMF 120 and/or the UE 200 (i.e., the LMF 120 and/or the UE 200 may be configured to perform one or more of these functions).

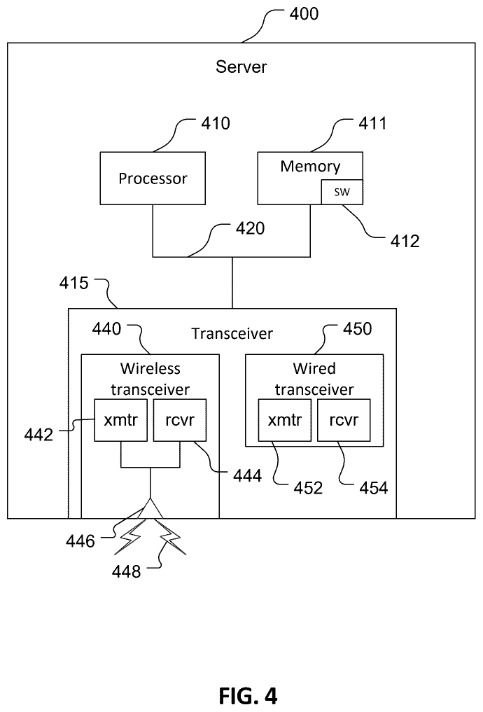

Referring also to FIG. 4, a server 400, of which the LMF 120 may be an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi®, WiFi® Direct (WiFi®-D), Bluetooth®, Zigbee® etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_(Rx→Tx) (i.e., UE TRx-Tx or UERx-Tx) between the ToA of the RTT measurement signal and the transmission time of the RTT response message in a payload of each RTT response message. The RTT response message would include a reference signal from which the base station can deduce the ToA of the RTT response. By comparing the difference T_(Tx→Rx) between the transmission time of the RTT measurement signal from the base station and the ToA of the RTT response at the base station to the UE-reported time difference T_(Rx→Tx), and subtracting the UERx-Tx, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nth resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence). Position information may include one or more positioning signal measurements (e.g., of one or more satellite signals, of PRS, and/or one or more other signals), and/or one or more values (e.g., one or more ranges (possibly including one or more pseudoranges), and/or one or more position estimates, etc.) based on one or more positioning signal measurements.

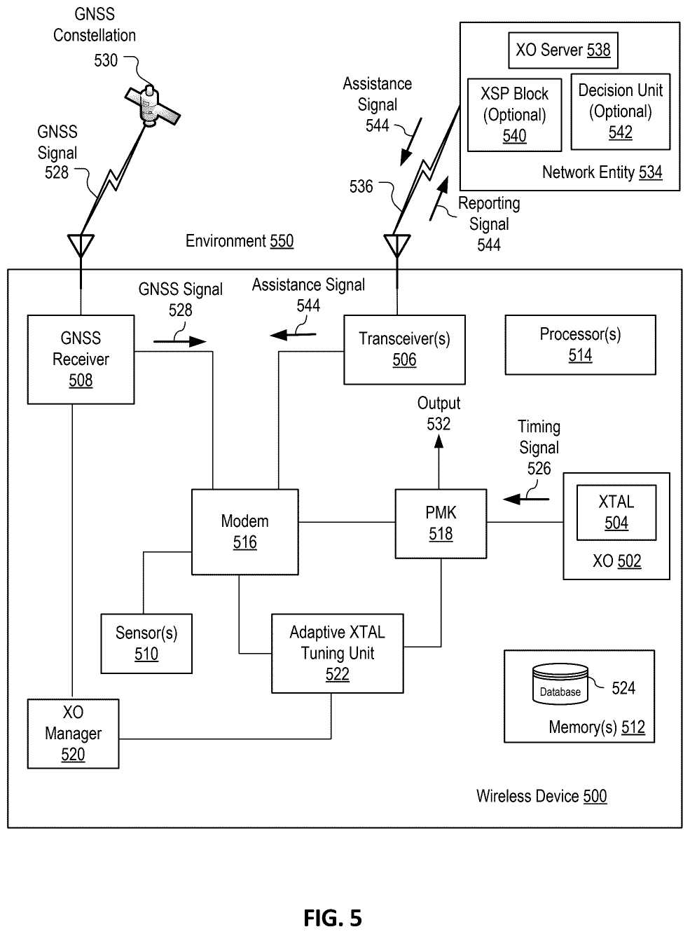

FIG. 5 is a functional system block diagram of an example of an implementation of a wireless device 500 for adaptive tuning of a crystal oscillator (XO) 502 having a crystal (XTAL) 504 in accordance with the present disclosure. The wireless device 500 may be a device that includes a GNSS receiver 503 or other RF protocols such as, for example, the IEEE 802.11 (i.e., Wi-Fi®), IEEE 802.15.1 (i.e., Bluetooth®), IEEE 802.15.4 (i.e., ZigBee), near field communication (NFC which is an RFID standard with also includes ISO/IEC 14443 and FeliCA), WWAN, etc.

In this example, the wireless device 500 may include the XO 502, the XTAL 504, at least one transceiver 506, the GNSS receiver 508, at least one sensor 510, at least one memory 512, and at least one processor 514. The at least one processor 514 is in signal communication with the at least one transceiver 506, at least one sensor 510, at least one memory 512, GNSS receiver 508, and the XO 502. In general, the wireless device 500 may be integrated into a signal integrated circuit (IC) or into a plurality of ICs on one or more printed circuit boards (PCBs). In this example, the XTAL 504 is a frequency-determining device known generally as a piezoelectric resonator that may be provided by different vendors. The XTAL 504 is placed on the PCB of the wireless device 500.

In general, the wireless device 500 may include a number of modules, elements, devices, and/or units that may be implemented in hardware, software, or both. As an example, the wireless device 500 may includes a number of functional elements/blocks such as, for example, a modem 516, a power and clock management IC (PMK) 518, an XO manager 520, an adaptive XTAL tuning unit 522, and a database 524. In this example, the PMK 518 may be a device, component, or circuit that is configured to control and manage the power and timing of the PCB within the wireless device 500. The XO manager 520 is configured to control the XO 502 functionality by interacting with various subsystems of the wireless device 500. The adaptive XTAL tuning unit 522 is configured to aid in the tuning the XO parameters dynamically in the field based on the instantaneous failure and field conditions; and obtain the optimal XO parameters instantaneously.

In this example, the XO manager 520, adaptive XTAL tuning unit 522, and parts of the modem 516 and PMK 518 may be optionally hardware components, software elements that may be configured and run on the at least one processor 514, or both. In this example, the XO manager 520 is configured to handle XO 502 error compensation.

In this example, the modem 516 may include hardware components that are common to both the at least one transceiver 506 and the GNSS receiver 508, where the baseband hardware is located within the modem 516 and the front-end hardware, for both the GNSS receiver 508 and the at least one transceiver 506, are located within the GNSS receiver 508 and the at least one transceiver 506, respectively. Moreover, the GNSS receiver 508 may be optionally a separate receiver device or part of the at least one transceiver 506. In this example, the XO 502 is in signal communication with at least one transceiver 506 and GNSS receiver 508 via the PMK 518 and modem 516. In this example, timing signals 526 from the XO 502 may be shared between the modem 516, the at least one transceiver 506, and the GNSS receiver 508 because the modem 516 may share some of the common electronics with both the at least one transceiver 506 and GNSS receiver 508. The database 524 may be stored on the at least one memory 512 and may include a lookup table.

In general, utilizing the techniques described herein, the wireless device 500 may include device logs for the XTAL 504 and the PCB utilized during the fabrication of the wireless device 500. The device logs may be initially stored in the database 524 and may include default XO parameters (also referred to as golden XO parameters) that are utilized to initially operate the wireless device 500. The techniques described then dynamically adjust the initial default XO parameters by initially comparing the default XO parameters against the KPI values for the wireless device to detect any instantaneous failures and then dynamically adjust the XO parameters against KPI values so as to meet the KPI values. This comparison may be an iterative process utilizing NBIQ iterations across potential XO parameters, where the wireless device 500 determines the optimal XO parameters to utilize in adjusting the XO 502. In this example, the KPI values may be selected from the XO temperature, XO temperature slope, XO temperature acceleration, NBIQ of a received GNSS signal (herein interchangeably referred to as a Global Positioning System (GPS) signal) 528, a maximum acceleration of a satellite (SV) of a constellation of GNSS satellites 530, and the cycle slip count of a carrier phase cycle of the received GNSS signal 528.

In an example of operation, the at least one processor 514 may be configured to: measure performance parameters of the wireless device 500 based on field conditions of the wireless device 500 with the at least one sensor 510; calibrate the XO parameters of the wireless device 500 with the performance parameters to generate updated XO parameters; and tune the XO 502 with the updated XO parameters. The at least one processor 514 may be further configured to retrieve the initial, or previously updated, XO parameters from the database 524. The performance parameters may include the XO temperature, XO temperature slope, XO temperature acceleration, NBIQ of a received GNSS signal 528, maximum acceleration of an SV of the constellation of GNSS satellites 530, and cycle slip count of the carrier phase cycle of the received GNSS signal 528. In this example, the field conditions may be the natural environmental conditions experienced by the XO 502 of the wireless device 500 in an environment 550 of operation of the wireless device 500 as opposed to a controlled environment such as, for example, a laboratory or manufacturing facility.

The at least one processor 514 may be configured to calibrate the XO parameters by being further configured to determine an instantaneous failure of the KPI values utilizing the XO parameters, where the KPI values are predetermined values; adjust the XO parameters with the performance parameters to generate the adjusted XO parameters; determine that the adjusted XO parameters achieve the KPI values; set the adjusted XO parameters as the updated XO parameters; and store the updated XO parameters, for example, in the lookup table of the database 524. In this example, the field conditions may be produced by the PMK 518 as an output signal 532. In this example, the techniques described herein may be performed on the wireless device 500 itself, such that the wireless device 500 optimizes the XO parameters on-the-fly under field conditions. The wireless device 500 optimizes the XO parameters by adaptively tuning the XO parameters dynamically in the field based on the instantaneous failures of meeting the KPI values and the field conditions so as to generate the optimal XO parameters instantaneously. Furthermore, the wireless device 500 is configured to periodically update the XO parameters to produce optimal XO parameters based on failure thresholds dynamically in the field. In this example, the predetermined KPI values may be the pass/fail specifications for a KPI. As an example, the XO temperature slope may be a KPI and its pass/fail criteria may be less than 1° C./second, where the 1° C./second may be a predetermined value based on a system study and simulation of the wireless device 500. In this example, any wireless device that exhibits a slope of greater than 1° C./second may be considered to fail the temperature slope KPI.

As another example of operation, the wireless device 500 may perform a procedure that includes turning on the wireless device 500, adaptively tuning the XO parameters that are stored in a lookup table of the database 524 with the adaptive XTAL tuning unit 522, and updating the lookup table with the optimal XO parameters with the XO manager 520. In this example, adaptively tuning the XO parameters may include determining a XO calibration state by determining whether the stored XO parameters meet a predetermined achievable XO calibration state. If they do, then the wireless device 500 utilizes the stored XO parameters as the optimal XO parameters. If, instead, the stored XO parameters do not meet the predetermined achievable XO calibration state, the wireless device 500 then performs a field calibration procedure. The XO manager 520 may then gather the field conditions from the at least one sensor 510 and KPI value failures from the adaptive XTAL tuning unit 522; perform an XO parameter optimization utilizing the field conditions and KPI value failures; and update the lookup table of the database 524. In this example, the XO manager 520 may apply the tuned XO parameters to the XTAL 504 and run the GNSS engine (which may be either in the GNSS receiver 508 or the modem 516) to check for GNSS KPI values such as, for example, NBIQ, maximum acceleration of an SV, cycle slips, etc. As an example, if logically the NBIQ is less than or equal to 150 Hz/second AND 1 second maximum acceleration of the SV is less than or equal to 3 meters/second² AND the 12 second maximum acceleration of the SV is less than or equal to 1.2 meters/second² AND the cycle slips are equal to zero (0), then the XO parameters are optimal and are updated in the lookup table of the database 524. If this logical test is not true, then perform another logical test on the XO parameters that includes determining if the XO 502 temperature range is between 0 degrees Celsius (° C.) and 25° C. AND the XO 502 temperature slope is greater than or equal to 1 0° C./second AND XO 502 temperature acceleration greater than or equal to 0.3° C./second², then the XO parameters are optimal and are updated in the lookup table of the database 524. If this logical test is not true, then repeat the step of the XO manager 520 applying the tuned XO parameters to the XTAL 504 and running the GNSS engine to check for GNSS KPI values. The XO manager 520 may also perform an additional test to determine if the XO 502 is overheated. This test includes determining if the NBIQ is less than or equal to 150 Hz/second AND the 1 second maximum acceleration of the SV is less than or equal to 8 meters/second² AND the 12 second maximum acceleration is less than or equal to 2 meters/second² AND the cycle slips are equal to 0. If true, the XO parameters are optimal and are updated in the lookup table of the database 524. If this logical test is not true, then determine if the XO 502 temperature range is less than 0° C. OR greater than 25° C. AND the XO 502 temperature slope is greater than or equal to 1° C./second AND the XO 502 temperature acceleration is greater than or equal to 0.3° C./second². If true, the XO parameters are optimal and are updated in the lookup table of the database 524. If this logical test is not true, then the XO 502 may be overheated and XO 502 may need to be recovered from overheating (i.e., cooled down). In the example, the logical “AND” and “OR” terms represent the logical operators for the set of Boolean operands.

In another example, a network entity (e.g., a server) 534, in signal communication with the wireless device 500, may generate and publish geo-specific models of the XO parameters for a plurality of wireless devices (i.e., wireless device 500) to use when the wireless devices are covered by the geo-specific models. In another example, the network entity 534 may provide multiple models across multiple wireless devices to test out XO parameters before publishing a finalized model of the optimal XO parameters. The network entity 534 may utilize contextual information provided by the wireless device into account for proactively updating model of optimal XO parameters.

For example, the wireless device 500 may be in signal communication with the network entity 534 (with is remote from the wireless device 500) via a signal path 536 from the at least one transceiver 506 to the network entity 534. The network entity 534 may be, or include, a server. The network entity 534 may include an at least one transceiver, at least one memory, and an at least one processor; and may include a number of functional elements/blocks such as, for example, an XO server block 538, an optional XO simulation playback (XSP) functional block 540, and an optional decision unit 542. The XSP functional block 540 is a functional element/block that performs XO simulation playback on XO parameters transmitted to the network entity 534. In this example, the XSP block 540 and decision unit 542 may be implemented as hardware, software, or both. If implemented in software, the logic performed by the XSP block 540 and decision unit 542 may be implemented by the at least one processor of the network entity 534. As an example, the XO server block 538 may include the at least one processor and may be configured to perform the logic functions of both the XSP block 540 and/or decision unit 542. The network entity 534 may optionally provide multiple models across multiple wireless devices to test (i.e., simulate) the XO parameters before publishing a finalized model of the XO parameters as optimal XO parameters. The network entity 534 may receive and utilize contextual information from the plurality of wireless devices for proactively updating the model of XO parameters.

If the network entity 534 is in signal communication with the wireless device 500 and the wireless device 500 is able to detect and receive an assistance signal 544 from network entity 534, the wireless device 500 may be configured to utilize the assistance signal 544 produced the optimal XO parameters to store in the lookup table of the database 524 and utilize to control the XO 502. In this example, the assistance signal 544 may be a WWAN type of signal from the network entity 534. As will be discussed later, the assistance signal 544 may include assistance XO parameters for the wireless device 500. In the previous example, if the assistance signal 544 is available, the adaptive XTAL tuning unit 522 may determine that the assistance signal 544 is available and then, without performing a field calibration, pass the assistance XO parameters from the assistance signal 544 to the XO manager 520. The XO manager 520 may then be configured to evaluate the assistance XO parameters, gather the field conditions from the at least one sensor 510 and KPI value failures from the adaptive XTAL tuning unit 522; perform an XO parameter optimization utilizing the field conditions and KPI value failures and the assistance XO parameters; and update the lookup table of the database 524 with the optimal XO parameters.

As another example, if the network entity 534 is available to assist the wireless device 500, the wireless device 500 may then be configured to adaptively tune the XO parameters dynamically in the field as per the specific failure and field such as, for example, NBIQ, maximum acceleration, cycle slips, temperature that the XTAL 504 is undergoing and tune XO parameters accordingly as described earlier. The resulting updated XO parameters may then be transmitted to the network entity 534 via a reporting signal 546. In response, the network entity 534 may receive the reporting signal 546; perform XO simulation playback, with the XSP block 540, on the updated XO parameters of the reporting signal 546; and select the most optimal XO parameters from the received updated XO parameters based on the decision unit 542. In this example, the network entity 534 may receive a plurality of reporting signals for a plurality of wireless devices and, in response, select the most optimal XO parameters for the assistance signal 544 (for the wireless device 500) from the updated XO parameters received via the responding reporting signal 546 from the wireless device 500 and other updated XO parameters received from other wireless devices via other reporting signals. In this example, the decision unit 542 may be a smart decision functional element that utilizes an algorithm on the XO server block 538 to consider multiple factors as the geography (i.e., the geolocation of the different wireless devices), time to first fix (TTFF), GNSS KPI specification values for each geolocation, enhanced lookup tables on the XO server block 538, and the most optimal parameters for all of the wireless devices historically.

In this example, the wireless device 500 may perform a method of operation that includes determining whether the assistance signal 544 from network entity 534 is available; receiving the assisted XO parameters of the assistance signal 544 from the network entity 534; measuring the performance parameters of the wireless device 500 based on field conditions of the wireless device 500 with the at least one sensor 510; calibrating the XO parameters of the wireless device 500 with the performance parameters and the assisted XO parameters from the assistance signal 544 to generate the updated XO parameters; and tuning the XO 502 with the updated XO parameters. The method of operation may also include determining an instantaneous failure of KPI values utilizing the XO parameters, where the KPI values are predetermined values; determining another instantaneous failure of the KPI values utilizing the assisted XO parameters; adjusting the XO parameters with the performance parameters or the assisted XO parameters to generate adjusted XO parameters; determining that the adjusted XO parameters achieve the KPI values; and setting the adjusted XO parameters as the updated XO parameters. Moreover, the method of operation may also include transmitting the updated XO parameters to the network entity 534 via the reporting signal 546 and storing the updated XO parameters in the database 524 as optimal XO parameters.

As another example of operation, the wireless device 500 may perform a procedure, similar to the previous example, that includes turning on the wireless device 500, adaptively tuning the XO parameters that are stored in a lookup table of the database 524 with the adaptive XTAL tuning unit 522, and updating the lookup table with the optimal XO parameters with the XO manager 520. In this example, adaptively tuning the XO parameters may include determining a XO calibration state by determining whether the stored XO parameters meet a predetermined achievable XO calibration state. If they do, then the wireless device 500 utilizes the stored XO parameters as the optimal XO parameters. If, instead, the stored XO parameters do not meet the predetermined achievable XO calibration state, the wireless device 500 then performs a field calibration procedure and determines if the assistance signal 544 is available. The adaptive XTAL tuning unit 522 determines whether the at least one transceiver 506 has received the assistance signal 544. If the at least one transceiver 506 has not received the assistance signal 544, the adaptive XTAL tuning unit 522 is placed in a monitoring state to monitor for the availability of the assistance signal 544 in the future. The XO manager 520 may then gather the field conditions from the at least one sensor 510 and KPI value failures from the adaptive XTAL tuning unit 522; perform an XO parameter optimization utilizing the field conditions, assisted XO parameter (if the assistance signal 544 is available) and KPI value failures; and prior to updating the lookup table of the database 524, transmitting the updated XO parameters to the network entity 534 via the reporting signal 546. In this example, the XO manager 520 may apply the tuned XO parameters to the XTAL 504 and run the GNSS engine (which may be either in the GNSS receiver 508 or the modem 516) to check for GNSS KPI values such as, for example, NBIQ, maximum acceleration of an SV, cycle slips, etc. As an example, if logically the NBIQ is less than or equal to 150 Hz/second AND 1 second maximum acceleration of the SV is less than or equal to 3 meters/second² AND the 12 second maximum acceleration of the SV is less than or equal to 1.2 meters/second² AND the cycle slips are equal to zero (0), then the XO parameters are potentially optimal and prior to updating the lookup table of the database 524, transmitting the updated XO parameters to the network entity 534 via the reporting signal 546. If this logical test is not true, then perform another logical test on the XO parameters that includes determining if the XO 502 temperature range is between 0 degrees Celsius (° C.) and 25° C. AND the XO 502 temperature slope is greater than or equal to 1° C./second AND XO 502 temperature acceleration greater than or equal to 0.3° C./second², then the XO parameters are potentially optimal and prior to updating the lookup table of the database 524, transmitting the updated XO parameters to the network entity 534 via the reporting signal 546. If this logical test is not true, then repeat the step of the XO manager 520 applying the tuned XO parameters to the XTAL 504 and running the GNSS engine to check for GNSS KPI values. The XO manager 520 may also perform an additional test to determine if the XO 502 is overheated. This test includes determining if the NBIQ is less than or equal to 150 Hz/second AND the 1 second maximum acceleration of the SV is less than or equal to 8 meters/second² AND the 12 second maximum acceleration is less than or equal to 2 meters/second² AND the cycle slips are equal to 0. If true, the XO parameters are potentially optimal and prior to updating the lookup table of the database 524, transmitting the updated XO parameters to the network entity 534 via the reporting signal 546. If this logical test is not true, then determine if the XO 502 temperature range is less than 0° C. OR greater than 25° C. AND the XO 502 temperature slope is greater than or equal to 1° C./second AND the XO 502 temperature acceleration is greater than or equal to 0.3° C./second². If true, the XO parameters are potentially optimal and prior to updating the lookup table of the database 524, transmitting the updated XO parameters to the network entity 534 via the reporting signal 546. If this logical test is not true, then the XO 502 may be overheated and XO 502 may need to be recovered from overheating (i.e., cooled down).

Once the potentially optimal XO parameters are transmitted to the network entity 534 (via the reporting signal 546) the network entity 534 receives the potentially optimal XO parameters and performs an XO simulation playback with the XSP block 540 for the potentially optimal XO parameters from the wireless device 500 and other wireless devices; and based on the XO simulation playback of the XSP block 540 and smart decision of the decision unit 542, the network entity 534 selects the most optimal XO parameters. The network entity 534 then pushes (i.e., transmits) the selected optimal XO parameters to all of the wireless devices (i.e., wireless device 500). The wireless device 500 then receives the selected optimal XO parameters via the assistance signal 544 and stores the selected optimal XO parameters into the lookup table of the database 524.

In these examples, the network entity 534 performs an method of operation that may include receiving, at the network entity 34, the plurality of sets of XO parameters from a plurality of wireless devices (including the wireless device 500), where each set of XO parameters have been tuned to an XO of a corresponding wireless device; determining the optimal set of XO parameters from the plurality of sets of XO parameters, and transmitting, from the network entity 534, the optimal set of XO parameters as an assistance signal 544 to the plurality of wireless devices, where the optimal set of XO parameters are configured to tune the corresponding XO of each wireless device. In this example, determining the optimal set of XO parameters may include calibrating the received plurality of sets of XO parameters to generate updated XO parameters; performing an XO simulation on the updated XO parameters with the XSP block 540 to determine if the updated XO parameters achieve the KPI values in the XO simulation, where the KPI values are predetermined values; and setting the updated XO parameters as the optimal set of XO parameters. In this example, calibrating the XO parameters may include determining an instantaneous failure of the KPI values utilizing the XO parameters, where the KPI values are predetermined values; adjusting the XO parameters to generate adjusted XO parameters; determining that the adjusted XO parameters achieve the KPI values, and setting the adjusted XO parameters as the updated XO parameters. As stated earlier, the KPI values may include XO temperature, XO temperature slope, XO temperature acceleration, NBIQ of the received GNSS signal 528, a maximum acceleration of a SV of a constellation of GNSS satellites 530, and a cycle slip count of a carrier phase cycle of the received GNSS signal 528. In this example, the plurality of wireless devices may be located at a plurality of geographical locations and determining the instantaneous failure of the KPI values may include determining the instantaneous failure for at least one wireless device, of the plurality of wireless devices, in a specific geographic location, of the plurality of geographical locations, utilizing the KPI values for the specific geographic location. Also adjusting the XO parameters may include adjusting the XO parameters for the specific geographic location to generate adjusted XO parameters for the specific geographic location. The method may further include determining that the adjusted XO parameters achieve the KPI values for the specific geographic location; setting the adjusted XO parameters as the updated XO parameters for the specific geographic location; setting the updated XO parameters as the optimal set of XO parameters for the specific geographic location; and transmitting, from the network entity 534, the optimal set of XO parameters for the specific location as the assistance signal (i.e., assistance signal 544) to the at least one wireless device (i.e., wireless device 500) of the specific geographical location.

The circuits, components, modules, and/or devices of, or associated with, the wireless device 500 and network entity 534 are described as being in signal communication and/or communicatively coupled with each other, where signal communication refers to any type of communication and/or connection between the circuits, components, modules, and/or devices that allows a circuit, component, module, and/or device to pass and/or receive signals and/or information from another circuit, component, module, and/or device. The communication and/or connection may be along any signal path between the circuits, components, modules, and/or devices that allows signals and/or information to pass from one circuit, component, module, and/or device to another and includes wireless or wired signal paths. The signal paths may be physical, such as, for example, conductive wires, electromagnetic wave guides, cables, attached and/or electromagnetic or mechanically coupled terminals, semi-conductive or dielectric materials or devices, or other similar physical connections or couplings. Additionally, signal paths may be non-physical such as free-space (in the case of electromagnetic propagation) or information paths through digital components where communication information may be passed from one circuit, component, module, and/or device to another in varying digital formats without passing through a direct electromagnetic connection.

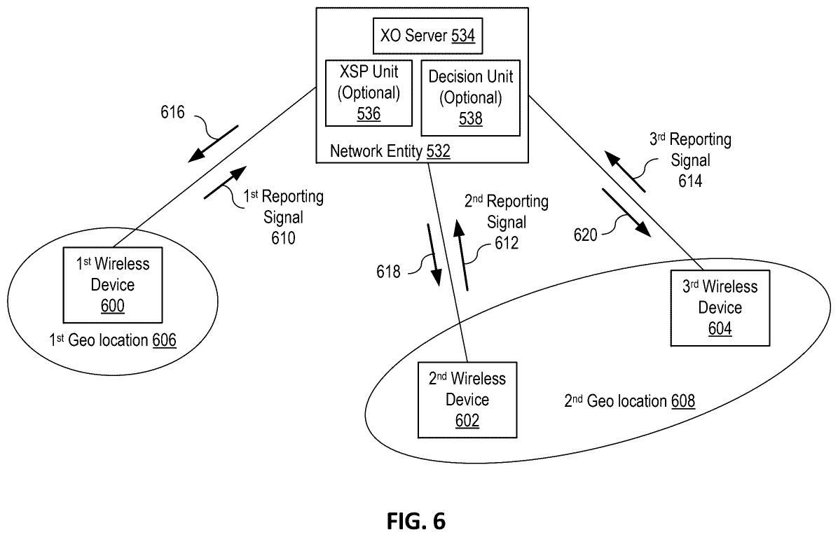

Turning to FIG. 6, a system block diagram is shown of the network entity 534 in signal communication with a plurality of wireless devices in different geographic locations in accordance with the present disclosure. For ease of illustration, only three wireless devices 600, 602, and 604 are shown in two geographic locations 606 and 608, respectively. While only three wireless devices 600, 602, and 604 and two geographic locations 606 and 608 are shown, it is appreciated that there may be any number of wireless devices and/or geographic locations without departing from the scope of the disclosure herein. In this example, first wireless device 600 is shown in the first geographic location 606 and the second wireless device 602 and third wireless device 604 are shown in the second geographic location 608. Each wireless device 600 may be similar to wireless device 500 described earlier. In an example of operation, the wireless devices 600, 602, and 604 would generate their respective sets of potentially optimal XO parameters and transmits then to network entity 534 via corresponding reporting signals 610, 612, and 614, respectively. In response and as described earlier in relation to FIG. 5, the network entity 534 would receive the sets of XO parameters from the wireless devices 600, 602, and 604 via the corresponding reporting signals 610, 612, and 614; determine the optimal set of XO parameters from the plurality of sets of XO parameters; and transmit the resulting optimal set of XO parameters to the wireless devices 600, 602, and 604 via the corresponding assistance signals 616, 618, and 620, respectively. As discussed earlier, in this example, the first wireless device 600 may also provide geographic identification information about its location within the first geographic location 606 within the first reporting signal 610 and the second wireless device 602 and third wireless device 604 may also provide geographic identification information about their locations with the second geographic location 608 via the corresponding second reporting signal 612 and third reporting signal 614, respectively. The network entity 534 may then customize the optimal set of XO parameters for the first wireless device 600 based on the first geographic location 606 and the optimal set of XO parameters for the second wireless device 602 and third wireless device 604 based on the second geographic location 608. As an example, in some situations, the optimal set of XO parameters of the corresponding second assistance signal 618 and third assistance signal 620 may be the same because both the second wireless device 602 and third wireless device 604 are located within the same geographic area (i.e., the second geographic location 608). Since both the second wireless device 602 and third wireless device 604 are located in the same geographic location, the second wireless device 602 and third wireless device 604 may be undergoing the same frequency temperature (FT) characteristics at a given time period. As such, if the second wireless device 602 and third wireless device 604 experience the same FT characteristics and have the same PCB layout then the XO parameters are expected to be the same for both.

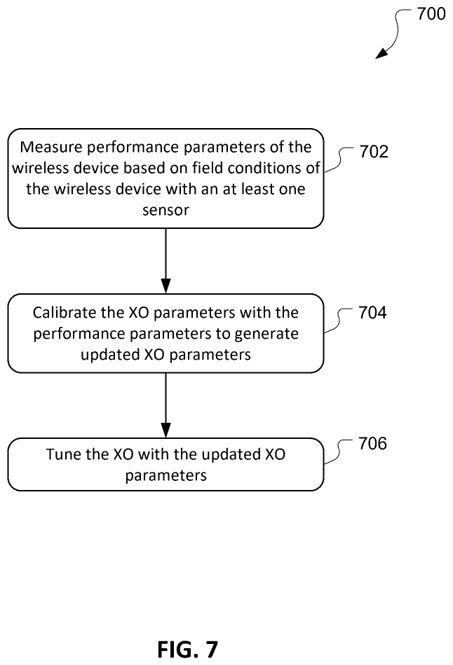

In FIG. 7, a flowchart of an example of an implementation of a method 700, performed by the wireless device 500, for adaptive XTAL tuning of the XO of the wireless device 500 is shown. In this example, the method 800 includes measuring 702 the performance parameters of the wireless device 500 based on field conditions of the wireless device 500 with an at least one sensor 510; calibrating 704 XO parameters of the wireless device 500 with the performance parameters to generate updated XO parameters; and tuning 706 the XO with the updated XO parameters. The method 800 may optionally further include retrieving the XO parameters from the database 524 within the at least one memory 512 of the wireless device 500. In this example, the performance parameters may be the XO temperature, XO temperature slope, XO temperature acceleration, NBIQ of the GNSS signal 528, maximum acceleration of an SV of the constellation of GNSS satellites 530, and a cycle slip count of a carrier phase cycle of the received GNSS signal 528. Calibrating 704 the XO parameters may include determining an instantaneous failure of the KPI values utilizing the XO parameters, where the KPI values are predetermined values; adjusting the XO parameters with the performance parameters to generate adjusted XO parameters; determining that the adjusted XO parameters achieve the KPI values; and setting the adjusted XO parameters as the updated XO parameters. As discussed previously, the KPI values may include XO temperature, XO temperature slope, XO temperature acceleration, NBIQ of the received global GNSS signal 528, maximum acceleration of the SV of the constellation of GNSS satellites 530, and the cycle slip count of a carrier phase cycle of the received GNSS signal 528. Further, the updated XO parameters may be configured to control properties of the XTAL that are selected from a group consisting of a temperature multiplier, a decay factor, thermal transients, hysteresis, an IIR filter coefficient, and a thermistor selection. The method 700 may further include storing the updated XO parameters in the database 524. The method 700 may also include determining whether there is an assistance signal 544 from the network entity 534 available and, if available, receiving the assisted XO parameters of the assistance signal 544 from the network entity 534, where calibrating 704 the XO parameters of the wireless device 500 with the performance parameters to generate the updated XO parameters may include utilizing the assisted XO parameters. The method 700 may further include determining an instantaneous failure of the KPI values utilizing the XO parameters, where the KPI values are predetermined values; determining another instantaneous failure of the KPI values utilizing the assisted XO parameters; adjusting the XO parameters with the performance parameters or the assisted XO parameters to generate adjusted XO parameters; determining that the adjusted XO parameters achieve the KPI values; and setting the adjusted XO parameters as the updated XO parameters. The method 700 may further optionally include transmitting the updated XO parameters, via the at least one transceiver 506, to the network entity 534 and storing the updated XO parameters in the database 524.

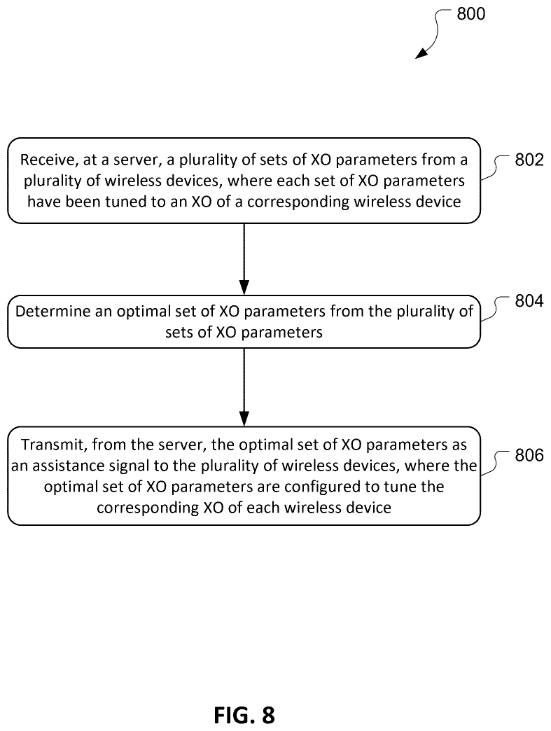

FIG. 8 is a flowchart of an example of an implementation of a method 800, performed by the network entity 534, for adaptive XTAL tuning of the XO of the wireless device 500. The method 800 may include receiving 802, at a server (i.e., network entity 534), a plurality of sets of XO parameters from a plurality of wireless devices, where each set of XO parameters have been tuned to an XO of a corresponding wireless device; determining 804 the optimal set of XO parameters from the plurality of sets of XO parameters, and transmitting 806, from the server, the optimal set of XO parameters as the assistance signal 544 to the plurality of wireless devices, wherein the optimal set of XO parameters are configured to tune the corresponding XO of each wireless device.

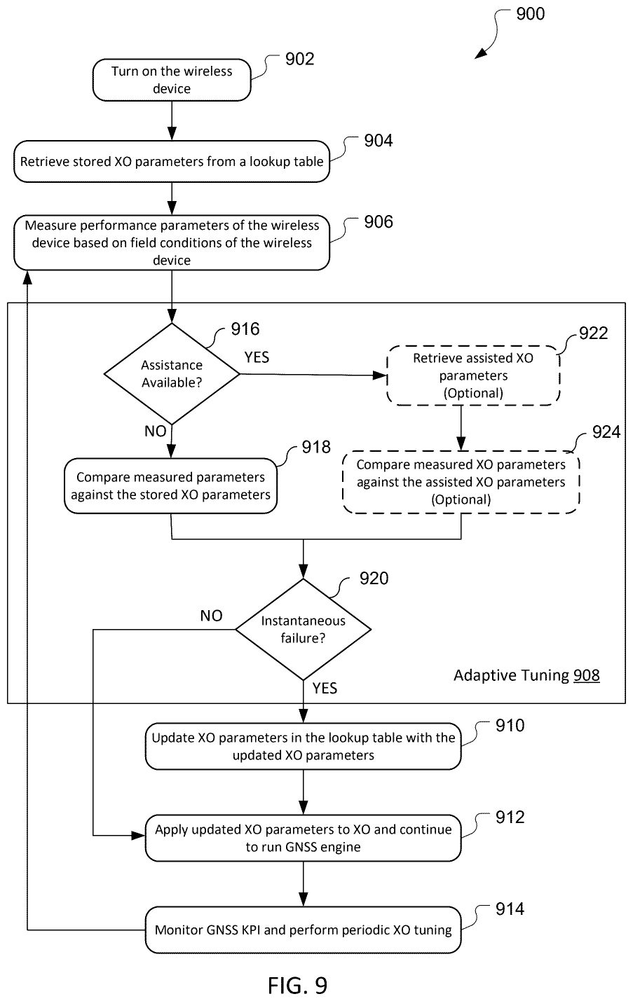

In FIG. 9, a flowchart of another example of an implementation of a method 900, performed by the wireless device 500, for adaptive XTAL tuning of the XO of the wireless device 500 is shown. The method 900 may include turning 902 on the wireless device 500, retrieving 904, the stored XO parameters from a lookup table in the database 524, and measuring 906 the performance parameters of the wireless device 500 based on the field conditions of the wireless device 500 with the at least one sensor 510. The method 900 may then include adaptive tuning 908 of the XO parameters; updating 910 the XO parameters in the lookup table with the updated XO parameters; applying 912 the updated XO parameters to the XO 502 and continue to run the GNSS engine of the GNSS receiver 508; and continue to monitor 914 the GNSS KPI and perform periodic XO tuning by returning to the measuring 906.

In this example, the adaptive tuning 908 may include determining 916 if the assistance signal 544 is available; if not, compare 918 the measured parameters against the stored XO parameters in the database 524; and determine 920 if an instantaneous failure has occurred.

If the assistance signal 544 is available, the method 900 may optionally include retrieving 922 the assisted XO parameters from the assistance signal 544 and comparing 924 the measured XO parameters against the assisted XO parameters. The method 900 then determine 920 if an instantaneous failure has occurred.

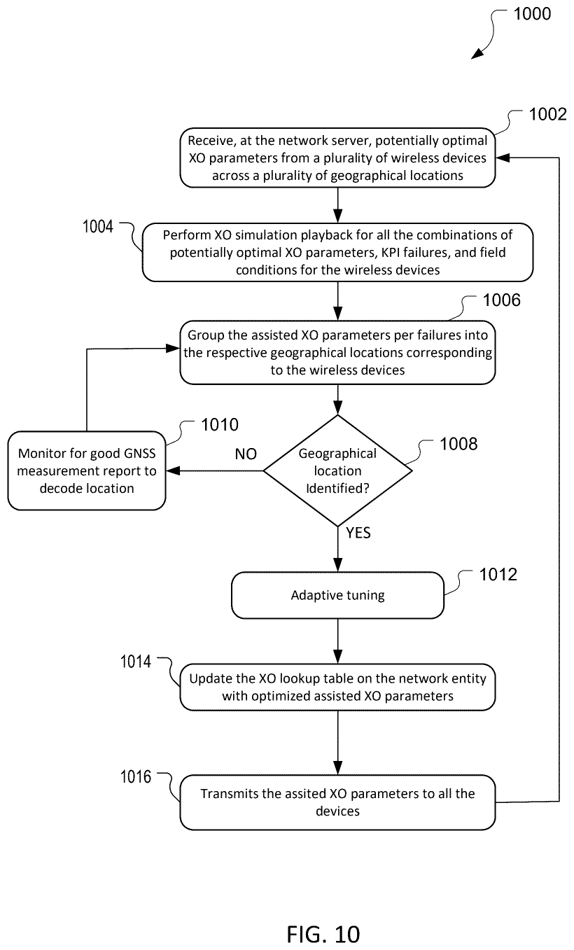

FIG. 10 is a flowchart of another example of an implementation of a method 1000, performed by the network entity 534, for adaptive XTAL tuning of the XO of the wireless device 500. The method 1000 includes receiving 1002, at the network entity 534, potentially optimal XO parameters from wireless devices across a plurality of geographical locations; performing XO simulation playback 1004 for all the combinations of received potentially optimal XO parameters, KPI failures, and field conditions for all of the wireless devices; grouping 1006 the assisted XO parameters per failures in into the respective geographic locations corresponding to the wireless devices; and determine 1008 if the geographic location of the wireless devices are identified. If the geographic location of the wireless devices are not identified, the method 1000 may monitor 1010 the reporting signals for good GNSS measurement report to decode the location of the wireless devices. If the geographic location is identified, the method 1000 adaptively tunes 1012 the XO parameters as described earlier; updates 1014 the XO lookup table at the network entity 534 with the optimized assisted XO parameters; and transmits 1016 the assisted XO parameters to the wireless devices. The method 1000 may then repeat.

### Implementation Examples

Implementation examples are provided in the following numbered clauses.

Clause 1. A method for adaptive tuning of a crystal oscillator (XO), having a crystal (XTAL), in a wireless device, the method including: measuring performance parameters of the wireless device based on field conditions of the wireless device with an at least one sensor, wherein the field conditions are natural environment conditions experienced by the XO; calibrating XO parameters of the wireless device with the performance parameters to generate updated XO parameters; and tuning the XO with the updated XO parameters.

Clause 2. The method of clause 1, further including retrieving the XO parameters from a database within at least one memory of the wireless device.

Clause 3. The method of clause 1, wherein the performance parameters are selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal.

Clause 4. The method of clause 1, wherein calibrating the XO parameters includes determining an instantaneous failure of key performance indicator (KPI) values utilizing the XO parameters, wherein the KPI values are predetermined values, adjusting the XO parameters with the performance parameters to generate adjusted XO parameters, determining that the adjusted XO parameters achieve the KPI values, and setting the adjusted XO parameters as the updated XO parameters.

Clause 5. The method of clause 4, wherein the KPI values are selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal.

Clause 6. The method of clause 5, wherein the updated XO parameters are configured to control properties of the XTAL that are selected from a group consisting of a temperature multiplier, a decay factor, thermal transients, hysteresis, an infinite impulse response (IIR) filter coefficient, and a thermistor selection.

Clause 7. The method of clause 4, further includes storing the updated XO parameters in a database within at least one memory of the wireless device.

Clause 8. The method of clause 1, further includes determining whether there is an assistance signal from a network entity available.

Clause 9. The method of clause 8, further includes receiving assisted XO parameters of the assistance signal from the network entity if the assistance signal is available, wherein calibrating the XO parameters of the wireless device with the performance parameters to generate the updated XO parameters includes utilizing the assisted XO parameters.

Clause 10. The method of clause 9, further includes determining an instantaneous failure of key performance indicator (KPI) values utilizing the XO parameters, wherein the KPI values are predetermined values, determining another instantaneous failure of the KPI values utilizing the assisted XO parameters, adjusting the XO parameters with the performance parameters or the assisted XO parameters to generate adjusted XO parameters, determining that the adjusted XO parameters achieve the KPI values, and setting the adjusted XO parameters as the updated XO parameters.

Clause 11. The method of clause 9, further including transmitting the updated XO parameters to the network entity.

Clause 12. The method of clause 1, further including storing the updated XO parameters in a database within at least one memory of the wireless device.

Clause 13. The method of clause 12, wherein the database includes a lookup table.

Clause 14. A wireless device comprising: a crystal oscillator (XO) having a crystal (XTAL); at least one transceiver; at least one sensor; at least one memory; and at least one processor, in signal communication with the XO, the at least one transceiver, the at least one sensor, and the at least one memory, the at least one processor configured to: measure performance parameters of the wireless device based on field conditions of the wireless device with the at least one sensor, wherein the field conditions are natural environment conditions experienced by the XO; calibrate XO parameters of the wireless device with the performance parameters to generate updated XO parameters; and tune the XO with the updated XO parameters.

Clause 15. The wireless device of clause 14, wherein the at least one processor is further configured to retrieve the XO parameters from a database within the at least one memory.

Clause 16. The wireless device of clause 14, wherein the performance parameters are selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal.

Clause 17. The wireless device of clause 14, wherein the at least one processor is configured to calibrate the XO parameters by further being configured to determine an instantaneous failure of key performance indicator (KPI) values utilizing the XO parameters, wherein the KPI values are predetermined values, adjust the XO parameters with the performance parameters to generate adjusted XO parameters, determine that the adjusted XO parameters achieve the KPI values, and set the adjusted XO parameters as the updated XO parameters.

Clause 18. The wireless device of clause 17, wherein the KPI values are selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal.

Clause 19. The wireless device of clause 18, wherein the updated XO parameters are configured to control properties of the XTAL that are selected from a group consisting of a temperature multiplier, a decay factor, thermal transients, hysteresis, an infinite impulse response (IIR) filter coefficient, and a thermistor selection.

Clause 20. The wireless device of clause 17, wherein the at least one processor is further configured to store the updated XO parameters in a database within the at least one memory.

Clause 21. The wireless device of clause 14, wherein the at least one processor is further configured to determine whether there is an assistance signal from a network entity available.

Clause 22. The wireless device of clause 21, wherein the at least one processor is further configured to receive assisted XO parameters of the assistance signal from the network entity via the at least one transceiver if the assistance signal is available, and utilize the assisted XO parameters to calibrate the XO parameters of the wireless device with the performance parameters to generate the updated XO parameters.

Clause 23. The wireless device of clause 22, wherein the at least one processor is further configured to determine an instantaneous failure of key performance indicator (KPI) values utilizing the XO parameters, wherein the KPI values are predetermined values, determine another instantaneous failure of the KPI values utilizing the assisted XO parameters, adjust the XO parameters with the performance parameters or the assisted XO parameters to generate adjusted XO parameters, determine that the adjusted XO parameters achieve the KPI values, and set the adjusted XO parameters as the updated XO parameters.

Clause 24. The wireless device of clause 22, wherein the at least one processor is further configured to transmit the updated XO parameters to the network entity via the at least one transceiver.

Clause 25. The wireless device of clause 14, wherein the at least one processor is further configured to store the updated XO parameters in a database within the at least one memory.

Clause 26. The wireless device of clause 25, wherein the database includes a lookup table.

Clause 27. A method for generating an optimal set of crystal oscillator (XO) parameters for a wireless device having a crystal (XTAL), the method including: receiving, at a server, a plurality of sets of XO parameters from a plurality of wireless devices, wherein each set of XO parameters have been tuned to an XO of a corresponding wireless device; determining the optimal set of XO parameters from the plurality of sets of XO parameters, and transmitting, from the server, the optimal set of XO parameters as an assistance signal to the plurality of wireless devices, wherein the optimal set of XO parameters are configured to tune the corresponding XO of each wireless device.

Clause 28. The method of clause 27, wherein determining the optimal set of XO parameters includes calibrating the received plurality of sets of XO parameters to generate updated XO parameters, performing an XO simulation on the updated XO parameters to determine if the updated XO parameters achieve key performance indicator (KPI) values in the XO simulation, wherein the KPI values are predetermined values, and setting the updated XO parameters as the optimal set of XO parameters.

Clause 29. The method of clause 28, wherein calibrating the XO parameters includes determining an instantaneous failure of key performance indicator (KPI) values utilizing the XO parameters, wherein the KPI values are predetermined values, adjusting the XO parameters to generate adjusted XO parameters, determining that the adjusted XO parameters achieve the KPI values, and setting the adjusted XO parameters as the updated XO parameters.

Clause 30. The method of clause 29, wherein the KPI values are selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal.

Clause 31. The method of clause 29, wherein the plurality of wireless devices are located at a plurality of geographical locations, determining the instantaneous failure of the KPI values includes determining the instantaneous failure for at least one wireless device, of the plurality of wireless devices, in a specific geographic location, of the plurality of geographical locations, utilizing the KPI values for the specific geographic location, adjusting the XO parameters includes adjusting the XO parameters for the specific geographic location to generate the adjusted XO parameters for the specific geographic location, determining that the adjusted XO parameters achieve the KPI values for the specific geographic location, setting the adjusted XO parameters as the updated XO parameters for the specific geographic location, setting the updated XO parameters as the optimal set of XO parameters for the specific geographic location, and transmitting, from the server, the optimal set of XO parameters for the specific location as the assistance signal to the at least one wireless device of the specific geographical location.

Clause 32. A server for providing an optimal set of crystal oscillator (XO) parameters for a plurality of wireless devices, each having a crystal (XTAL), the server including: at least one transceiver; at least one memory; and at least one processor, in signal communication with the at least one transceiver, and the at least one memory, the at least one processor configured to: receive, via the at least one transceiver, a plurality of sets of XO parameters from the plurality of wireless devices, wherein each set of XO parameters has been tuned to an XO of a corresponding one of the plurality of wireless devices; determine the optimal set of XO parameters from the plurality of sets of XO parameters, and transmit, via the at least one transceiver to the plurality of wireless devices, the optimal set of XO parameters as an assistance signal to the plurality of wireless devices.

Clause 33. The server of clause 32, wherein the at least one processor is configured to determine the optimal set of XO parameters by further being configured to calibrate the received plurality of sets of XO parameters to generate updated XO parameters, perform an XO simulation on the updated XO parameters to determine if the updated XO parameters achieve key performance indicator (KPI) values in the XO simulation, wherein the KPI values are predetermined values, and set the updated XO parameters as the optimal set of XO parameters.

Clause 34. The server of clause 33, wherein the at least one processor is configured to calibrate the XO parameters by further being configured to determine an instantaneous failure of key performance indicator (KPI) values utilizing the XO parameters, wherein the KPI values are predetermined values, adjust the XO parameters to generate adjusted XO parameters, determine that the adjusted XO parameters achieve the KPI values, and set the adjusted XO parameters as the updated XO parameters.

Clause 35. The server of clause 34, wherein the KPI values are selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal.

Clause 36. The server of clause 34, wherein the plurality of wireless devices are located at a plurality of geographical locations, and wherein the at least one processor is configured to determine the instantaneous failure of the KPI values by further being configured to determine the instantaneous failure for at least one wireless device, of the plurality of wireless devices, in a specific geographic location, of the plurality of geographical locations, utilizing the KPI values for the specific geographic location, adjust the XO parameters by further being configured to adjust the XO parameters for the specific geographic location to generate the adjusted XO parameters for the specific geographic location, determine that the adjusted XO parameters achieve the KPI values for the specific geographic location, set the adjusted XO parameters as the updated XO parameters for the specific geographic location, set the updated XO parameters as the optimal set of XO parameters for the specific geographic location, and transmit, via the at least one transceiver, the optimal set of XO parameters for the specific location as the assistance signal to the at least one wireless device of the specific geographical location.

Clause 37. A wireless device for adaptive tuning of a crystal oscillator (XO), having a crystal (XTAL), the wireless device including: means for measuring performance parameters of the wireless device based on field conditions of the wireless device, wherein the field conditions are natural environment conditions experienced by the XO; means for calibrating XO parameters of the wireless device with the performance parameters to generate updated XO parameters; and means for tuning the XO with the updated XO parameters.

Clause 38. The wireless device of clause 37, wherein means for calibrating the XO parameters includes means for determining an instantaneous failure of key performance indicator (KPI) values utilizing the XO parameters, wherein the KPI values are predetermined values, means for adjusting the XO parameters with the performance parameters to generate adjusted XO parameters, means for determining that the adjusted XO parameters achieve the KPI values, and means for setting the adjusted XO parameters as the updated XO parameters.

Clause 39. The wireless device of clause 37, further includes means for determining whether there is an assistance signal from a network entity available.

Clause 40. The wireless device of clause 39, further includes means for receiving assisted XO parameters of the assistance signal from the network entity if the assistance signal is available, wherein means for calibrating the XO parameters of the wireless device with the performance parameters to generate the updated XO parameters includes means for utilizing the assisted XO parameters.

Clause 41. The wireless device of clause 40, further includes means for determining an instantaneous failure of key performance indicator (KPI) values utilizing the XO parameters, wherein the KPI values are predetermined values, means for determining another instantaneous failure of the KPI values utilizing the assisted XO parameters, means for adjusting the XO parameters with the performance parameters or the assisted XO parameters to generate adjusted XO parameters, means for determining that the adjusted XO parameters achieve the KPI values, means for setting the adjusted XO parameters as the updated XO parameters, and means for transmitting the updated XO parameters to the network entity.

42. A server for generating an optimal set of crystal oscillator (XO) parameters for a wireless device having a crystal (XTAL), the server including: means for receiving a plurality of sets of XO parameters from a plurality of wireless devices, wherein each set of XO parameters have been tuned to an XO of a corresponding wireless device; means for determining the optimal set of XO parameters from the plurality of sets of XO parameters; and means for transmitting, from the server, the optimal set of XO parameters as an assistance signal to the plurality of wireless devices, wherein the optimal set of XO parameters are configured to tune the corresponding XO of each wireless device.

43. A non-transitory processor-readable storage medium comprising processor-readable instructions configured to cause one or more processors of a wireless device to adaptive tune a crystal oscillator (XO), having a crystal (XTAL), comprising: code for measuring performance parameters of the wireless device based on field conditions of the wireless device, wherein the field conditions are natural environment conditions experienced by the XO; code for calibrating XO parameters of the wireless device with the performance parameters to generate updated XO parameters; and code for tuning the XO with the updated XO parameters.

44. A non-transitory processor-readable storage medium comprising processor-readable instructions configured to cause one or more processors of a server to generate an optimal set of crystal oscillator (XO) parameters for a wireless device having a crystal (XTAL), comprising: code for receiving a plurality of sets of XO parameters from a plurality of wireless devices, wherein each set of XO parameters have been tuned to an XO of a corresponding wireless device; code for determining the optimal set of XO parameters from the plurality of sets of XO parameters; and code for transmitting, from the server, the optimal set of XO parameters as an assistance signal to the plurality of wireless devices, wherein the optimal set of XO parameters are configured to tune the corresponding XO of each wireless device.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. For example, one or more functions, or one or more portions thereof, discussed above as occurring in a network entity 534 may be performed outside of the network entity 534.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

What is claimed:

1. A method for adaptive tuning of a crystal oscillator (XO), having a crystal (XTAL), in a wireless device, the method including:
measuring performance parameters of the wireless device based on field conditions of the wireless device with an at least one sensor, wherein the field conditions are natural environment conditions experienced by the XO;
calibrating XO parameters of the wireless device with the performance parameters to generate updated XO parameters; and
tuning the XO with the updated XO parameters.

2. The method of claim 1, wherein the performance parameters are selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal.

3. The method of claim 1, wherein calibrating the XO parameters includes determining an instantaneous failure of key performance indicator (KPI) values utilizing the XO parameters, wherein the KPI values are predetermined values,
adjusting the XO parameters with the performance parameters to generate adjusted XO parameters,
determining that the adjusted XO parameters achieve the KPI values, and
setting the adjusted XO parameters as the updated XO parameters.

4. The method of claim 3, wherein
the KPI values are indicative of KPIs selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal; and
the updated XO parameters are configured to control properties of the XTAL that are selected from a group consisting of a temperature multiplier, a decay factor, thermal transients, hysteresis, an infinite impulse response (IIR) filter coefficient, and a thermistor selection.

5. The method of claim 1, further includes determining whether there is an assistance signal from a network entity available.

6. The method of claim 5, further includes
receiving assisted XO parameters of the assistance signal from the network entity if the assistance signal is available,
wherein calibrating the XO parameters of the wireless device with the performance parameters to generate the updated XO parameters includes utilizing the assisted XO parameters.

7. The method of claim 6, further includes
determining an instantaneous failure of key performance indicator (KPI) values utilizing the XO parameters, wherein the KPI values are predetermined values,
determining another instantaneous failure of the KPI values utilizing the assisted XO parameters,
adjusting the XO parameters with the performance parameters or the assisted XO parameters to generate adjusted XO parameters,
determining that the adjusted XO parameters achieve the KPI values, and
setting the adjusted XO parameters as the updated XO parameters.

8. The method of claim 6, further including transmitting the updated XO parameters to the network entity.

9. A wireless device comprising:
a crystal oscillator (XO) having a crystal (XTAL);
at least one transceiver;
at least one sensor;
at least one memory; and
at least one processor, in signal communication with the XO, the at least one transceiver, the at least one sensor, and the at least one memory, the at least one processor configured to:
measure performance parameters of the wireless device based on field conditions of the wireless device with the at least one sensor, wherein the field conditions are natural environment conditions experienced by the XO;
calibrate XO parameters of the wireless device with the performance parameters to generate updated XO parameters; and
tune the XO with the updated XO parameters.

10. The wireless device of claim 9, wherein the performance parameters are selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal.

11. The wireless device of claim 9, wherein the at least one processor is configured to calibrate the XO parameters by further being configured to
determine an instantaneous failure of key performance indicator (KPI) values utilizing the XO parameters, wherein the KPI values are predetermined values,
adjust the XO parameters with the performance parameters to generate adjusted XO parameters,
determine that the adjusted XO parameters achieve the KPI values, and
set the adjusted XO parameters as the updated XO parameters.

12. The wireless device of claim 11, wherein
the KPI values are selected from the group consisting of an XO temperature, an XO temperature slope, an XO temperature acceleration, narrow band in-phase and quadrature components (NBIQ) of a received global navigation satellite system (GNSS) signal, a maximum acceleration of a satellite (SV) of a constellation of GNSS satellites, and a cycle slip count of a carrier phase cycle of the received GNSS signal; and
the updated XO parameters are configured to control properties of the XTAL that are selected from a group consisting of a temperature multiplier, a decay factor, thermal transients, hysteresis, an infinite impulse response (IIR) filter coefficient, and a thermistor selection.

13. The wireless device of claim 9, wherein the at least one processor is further configured to determine whether there is an assistance signal from a network entity available.

14. The wireless device of claim 13, wherein the at least one processor is further configured to
receive assisted XO parameters of the assistance signal from the network entity via the at least one transceiver if the assistance signal is available, and
utilize the assisted XO parameters to calibrate the XO parameters of the wireless device with the performance parameters to generate the updated XO parameters.

15. The wireless device of claim 14, wherein the at least one processor is further configured to
determine an instantaneous failure of key performance indicator (KPI) values utilizing the XO parameters, wherein the KPI values are predetermined values,
determine another instantaneous failure of the KPI values utilizing the assisted XO parameters,
adjust the XO parameters with the performance parameters or the assisted XO parameters to generate adjusted XO parameters,
determine that the adjusted XO parameters achieve the KPI values, and
set the adjusted XO parameters as the updated XO parameters.

16. The wireless device of claim 14, wherein the at least one processor is further configured to transmit the updated XO parameters to the network entity via the at least one transceiver.

17. A wireless device for adaptive tuning of a crystal oscillator (XO), having a crystal (XTAL), the wireless device including:
means for measuring performance parameters of the wireless device based on field conditions of the wireless device, wherein the field conditions are natural environment conditions experienced by the XO;
means for calibrating XO parameters of the wireless device with the performance parameters to generate updated XO parameters; and
means for tuning the XO with the updated XO parameters.

18. The wireless device of claim 17, wherein means for calibrating the XO parameters includes
means for determining an instantaneous failure of key performance indicator (KPI) values utilizing the XO parameters, wherein the KPI values are predetermined values,
means for adjusting the XO parameters with the performance parameters to generate adjusted XO parameters,
means for determining that the adjusted XO parameters achieve the KPI values, and
means for setting the adjusted XO parameters as the updated XO parameters.

19. The wireless device of claim 17, further includes means for determining whether there is an assistance signal from a network entity available.

20. The wireless device of claim 19, further includes
means for receiving assisted XO parameters of the assistance signal from the network entity if the assistance signal is available,
wherein means for calibrating the XO parameters of the wireless device with the performance parameters to generate the updated XO parameters includes means for utilizing the assisted XO parameters.
